(19) United States
(12) Patent Application Publication
(10) Pub. No.: US 2013/0032642 A1
(43) Pub. Date: Feb. 7, 2013

(54) SECONDARY-AIR NOZZLE OF A TWO-FLOW JET ENGINE HAVING SEPARATED FLOWS INCLUDING A GRID THRUST REVERSER

(71) Applicants: Stephane Bensilum, Alfortville (FR); Jean Bertucchi, Thiais (FR)

(72) Inventors: Stephane Bensilum, Alfortville (FR); Jean Bertucchi, Thiais (FR)

(73) Assignee: SNECMA, Paris (FR)

(21) Appl. No.: 13/577,554

(22) PCT Filed: Feb. 4, 2011
(86) PCT No.: PCT/FR2011/050228

§ 371 Date: Oct. 23, 2012

(30) Foreign Application Priority Data
Feb. 8, 2010 (FR) 1050873

(51) Int. Cl. B64D 33/04

(52) U.S. Cl. 239/127.1

(57) ABSTRACT

A secondary-air nozzle of a two-flow jet engine having separated flows including an annular cowl element translatably mobile in an axial direction between an upstream retracted position allowing the engine to operate under direct thrust and a downstream extended position, and a grid thrust reverser including cylindrical ring sectors coaxial with the cowl element, including blades with a radial setting, and axially separated to provide radial guide passages therebetween, the cowl element opening the radial guide passages in the downstream extended position through the thrust reverser grids. The radius of the ring sectors forming the grids is not constant around the circumference of the cowl element, the radius of transverse cuts of at least one of the walls not being constant, when moving around the circumference of the cowl element, the cuts being made between the upstream edge of the cowl element and the downstream edge thereof.

The present invention relates to the field of bypass turbojets and the arrangement of the nacelle forming their casing, taking account of the installation constraints on an aircraft. More particularly its subject is the cold-flow nozzle of a bypass turbojet with separate flows incorporating a cascade vane thrust reverser.

### DESCRIPTION OF THE PRIOR ART

The invention relates notably to bypass turbojets comprising an upstream fan. Upstream and downstream are defined in the present document in relation to the direction of flow of the gases in the engine. The air entering the engine is compressed by the fan. An internal annular portion forms the main flow and is guided to the inside of the engine portion forming the gas generator; an outer annular portion of the air coming from the fan forms the bypass flow; it is straightened out in the axis of the engine and bypasses the latter. The bypass flow is discharged into the atmosphere either directly, separately from the main flow, or after having been mixed with the latter. The ratio between the bypass flow and the main flow, called the bypass ratio may be considerable because it is one of the parameters having an influence on the specific fuel consumption of the engine. A high bypass ratio also provides a gain with respect to the noise nuisance generated by the engine.

The present invention relates to engines in which the nacelle which is the casing is arranged so that the flows are separated: the main and bypass flows are discharged separately in two coaxial flows. The main flow is on the inside and the bypass flow is therefore discharged through an annular nozzle formed internally by the fairing of the gas generator and externally by an annular cap element. This cap element of the nacelle may consist either of a single annular part or of several parts placed in a ring for example in two half-rings placed on either side of an attachment to a pylon in an under-wing mounting.

The invention relates more particularly to engines with separated-flow nozzles comprising a thrust reverser of the cascade vane type. This type of thrust reverser known per se is illustrated in attached FIGS. 1 and 2, taken from patent EP 1.004.766 of the present applicant. These figures show schematically an example of a cold-flow nozzle with cascade vane thrust reverser. The thrust reverser comprises a downstream cap element 7 of the nacelle forming the cold-flow nozzle. It can be moved in translation in the downstream direction from a retracted position in which it forms the outer wall of the annular, cold-flow duct 17, when the turbojet is operating in direct thrust to a thrust-reversal position. It is set in motion for example by cylinders 4 attached to the upstream portion of the nacelle. The downstream movement of the element 7 causes a plurality of flaps 12 secured to the cap element to tilt which close off the duct 17 and divert the cold flow in a radial direction. The flaps 12 are controlled by connecting rods 14 attached via an articulation 15 to the inner wall 16 formed by the fairing of the gas generator.

In this thrust-reversal position, it reveals radial passageways placing the duct 17 in communication with the outside through the nacelle. The radial passageways are defined upstream by deviation edges 9 formed on the fixed upstream portion 6 of the nacelle. The cold flow is guided along these deviation edges. A plurality of cascade vanes 8 in ring sectors is placed across the passageways on the periphery of the cold-flow duct 17.

The cascade vanes are formed from fins 81, in ring sectors, oriented radially relative to the axis of the engine and arranging channels between them so as to guide the flow that passes through them to the outside with a component to the upstream of the engine in order to form a reverse thrust. The ring-sector fins are placed parallel to one another, along the axis of the engine, forming cascade vanes in portions of a cylinder coaxial with the cap element that can move in translation.

When aiming at engines with a high bypass ratio and consequently with a large fan diameter, the problem arises of mounting them on the aircraft. When the engine must be installed under the wing of the aircraft, it is usually suspended on a pylon secured to the wing. Usually the problem of bulk of large-diameter engines with their nacelle is alleviated by placing them as far upstream as possible relative to the leading edge of the wing. However, their rear portion remains close to the wing, and it must be situated at a lower height than that of the wing. Account must therefore be taken of the interaction of the exiting gas flow, notably the bypass flow on the periphery, with the surface of the wing, generating drag. It is also necessary to provide ground clearance that is sufficient for it to have no contact during maneuvers.

### SUMMARY OF THE INVENTION

The present applicant has set itself as an objective to mount an engine under the wing of an aircraft without having to sacrifice the fan diameter of the latter. In other words, this involves mounting an engine with the largest possible fan diameter, taking account of the constraints imposed by the height from the ground of the aircraft wing.

The particular objective set by the applicant is to produce the rear portion of the nacelle of the engine such that its height can be reduced. Because the overall diameter of the engine at the rear is that of the cold-flow nozzle and more particularly of the outer cap element of the nozzle, the applicant has set itself the objective to reduce the vertical dimension thereof.

According to the invention, this objective is achieved with a cold-flow nozzle of a bypass turbojet with separate flows having the features of the main claim.

Radius is intended to mean the distance between the cascade vanes at a point in question of the periphery and the axis of the engine.

By varying the radial position of the thrust-reversing cascade vanes in the azimuthal direction, it is possible to cause the bulk of the nacelle to vary on the azimuth and therefore to ovalize or deform the cap element so as to adapt it to the bulk constraints of its environment.

According to one particular embodiment, the radii of the cascade vanes change between a minimal value and a maximal value, the two values corresponding to planes, radial passing through the axis, perpendicular to one another. More particularly, of the two planes one is vertical, the other horizontal. The shape of the cascade vanes according to a simple embodiment is oval or substantially oval. The large axis of the oval is for example horizontal, but depending on the environment of the engine, it may be inclined relative to the horizontal direction.

According to another feature, the upstream edge, called the deviation edge, of the radial passageways, is of convex curved shape, the length of its section through a radial plane passing through the axis being constant along the circumference of the cap element.

According to a variant of the preceding embodiment, the upstream edge, called the deviation edge of the radial passageways, is of convex curved shape, the length of its section through a radial plane passing through the axis varying along the circumference of the cap element.

This gives a means of aerodynamic adjustment of the cold air flow when the thrust reverser is in the active position.

According to another feature, the length of the cascade vanes measured axially is constant along the circumference of the cap element or it varies along the circumference of the cap element.

More particularly, said cross sections of at least one of the transverse walls have an oblong shape, notably the smallest of said radii is vertical. This is the simplest solution for solving the problem of vertical bulk of the rear portion of the bypass flow nacelle.

According to one particular embodiment, the downstream edge of the cap element is circular. This embodiment has the advantage of deforming or ovalizing only a portion of the inner nozzle, not the discharge zone, thus limiting the aerodynamic problems associated with the ovalization or deformation of the nozzle.

### BRIEF DESCRIPTION OF THE FIGURES

Other features and advantages of the invention will emerge on reading the following description, with reference to the appended figures which represent respectively:

FIG. 1, a schematic half view in longitudinal section through a plane passing through the rotation axis of an associated turbojet, of a cascade vane thrust reverser, in the closed position, of a known type;

FIG. 2, a schematic half view in section similar to that of FIG. 1 of the thrust reverser shown in FIG. 1 in an operating configuration in thrust reversal;

FIG. 3, a schematic view in longitudinal section of a turbojet with cascade vane thrust reverser;

FIG. 4, a schematic view, in the axis of the engine, of the thrust-reverser cascade vanes according to the prior art;

FIG. 5, a schematic view, along the axis of the engine, of the thrust-reverser cascade vanes according to an exemplary embodiment of the invention;

FIG. 6, schematically, the relative position of two sections of the nozzle along planes passing through the axis, one being the vertical plane, the other the horizontal plane;

FIG. 7, a schematic view, along the axis of the engine, of the thrust-reverser cascade vanes according to another exemplary embodiment of the invention;

FIG. 8, a schematic view, along the axis of the engine, of the thrust-reverser cascade vanes according to yet another exemplary embodiment of the invention;

FIG. 9, schematically, the relative position of two sections of the nozzle along planes passing through the axis, one being the vertical plane, the other the horizontal plane, in the case of another embodiment;

FIG. 10, schematically, the relative position of two sections of the nozzle along planes passing through the axis, one being the vertical plane, the other the horizontal plane, in the case of yet another embodiment.

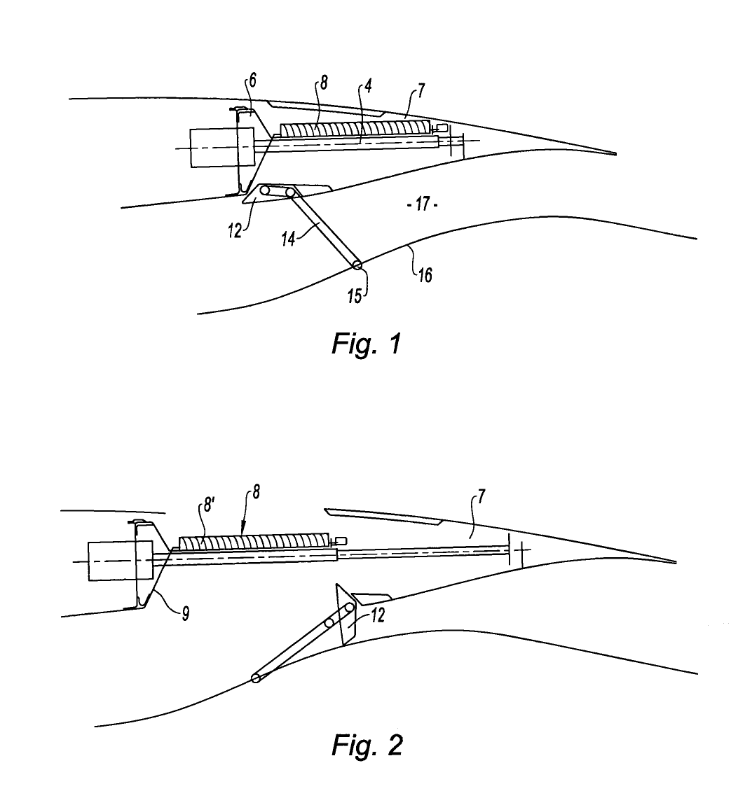

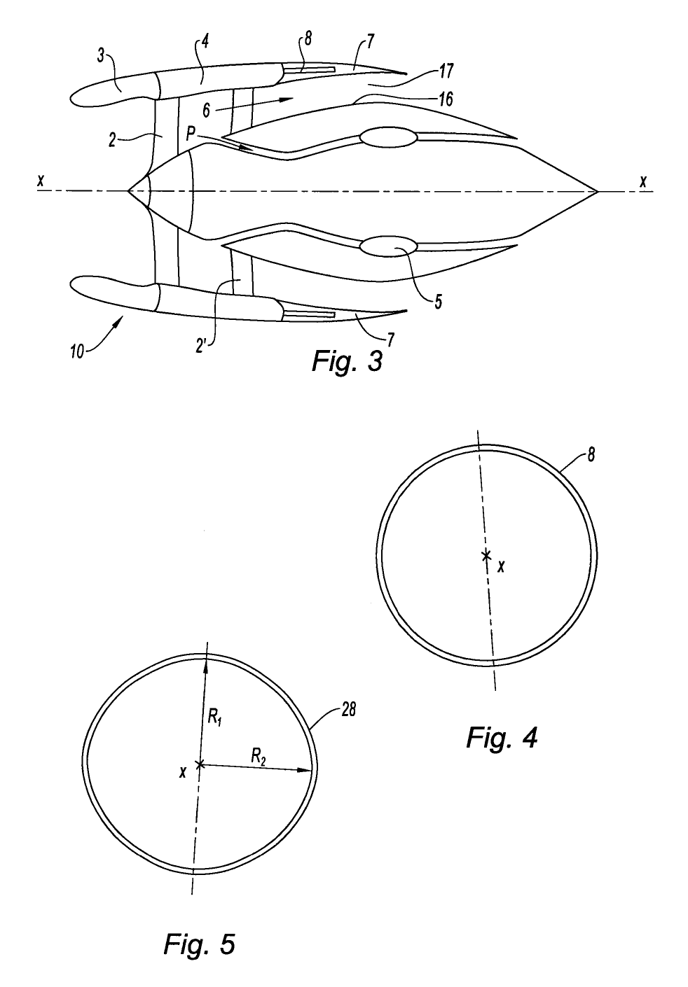

As can be seen in FIG. 3, a bypass turbojet, with separate flows and with a front fan, comprises a fan rotor 2 inside a fan casing itself enveloped in a nacelle the shape of which is adapted to the aerodynamic requirements.

Downstream of the fan, a portion of the air, the main flow P, is guided to the inside of the engine forming the gas generator. This main air P is compressed and feeds an annular combustion chamber 5. The combustion gases are expanded in various turbine stages which drive the fan and compressor rotors. Downstream, the main flow is discharged into the main discharge nozzle of hot gases.

The rest of the air from the fan forms the bypass air flow S the duct of which is coaxial with that of the main flow. The bypass flow is straightened up in the axis XX of the engine by the guide blades 2′ and the arms of the intermediate casing and then discharged through the bypass flow nozzle.

The nacelle comprises an annular air inlet 3, formed for feeding the engine, attached to the fan casing. The fan casing is enveloped with a fixed nacelle element 4 which extends to downstream of the blades 2′ straightening up the bypass air flow from the fan. In line with this fixed portion 4 of nacelle the cap element 7 forming an annular nozzle with the fairing of the gas generator is mounted.

As has already been described above, the cap element 7 can move in translation to reveal the thrust-reverser cascade vanes 8 when, on landing, it is necessary to reduce the speed of the aircraft by creating a thrust in the reverse direction relative to the direct thrust.

In the nozzles of the prior art, the assembly of the cap element 7 and the cascade vanes 8 in which they are housed form a volume of revolution about the axis of the engine.

FIG. 4 shows schematically the appearance of the assembly of the cascade vanes, alone, as seen in the axis XX of the machine. The assembly is circular.

According to the invention, the annular assembly of the cascade vanes is modified such that the radius, measured from the axis XX, is not constant when moving over the circumference of the cap element.

An exemplary embodiment is shown in FIG. 5. The assembly of cascade vanes that is indicated as a cascade vane, 28, has a radius R1, relative to the axis XX, in the vertical plane passing through the axis XX, and a radius R2 in the horizontal plane passing through the axis where R1<R2. The shape of the cascade vane 28 is substantially oval with a large horizontal axis and a small vertical axis.

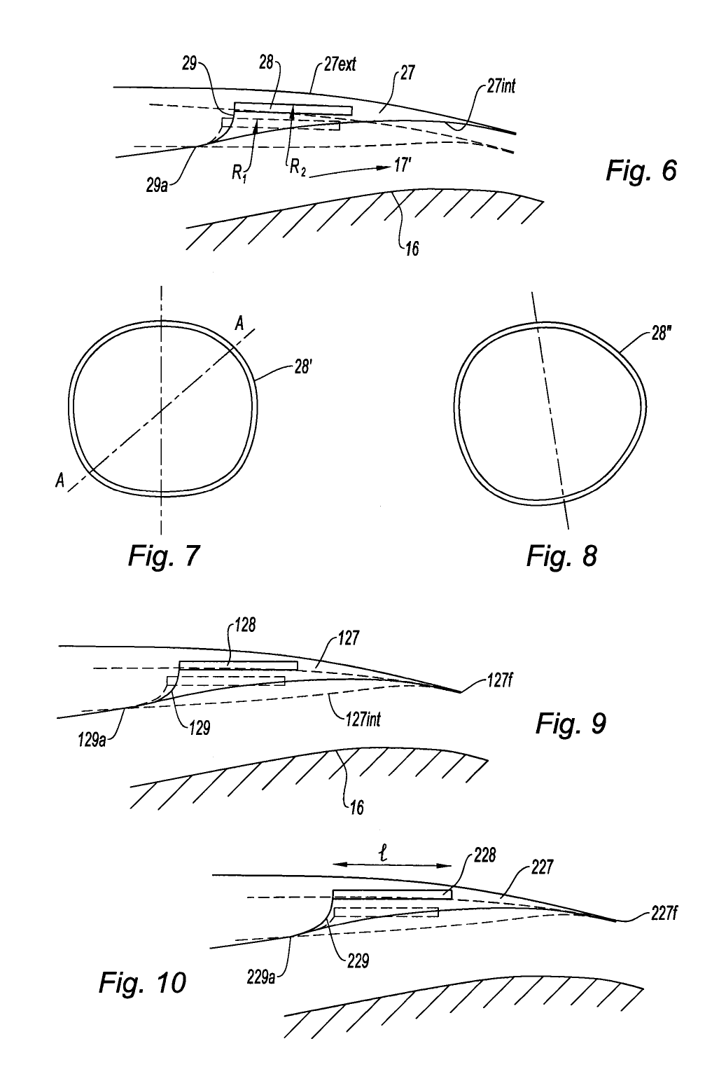

Shown in FIG. 6 is the shape of the nozzle relative to the axis in the two planes, respectively vertical and horizontal. For the purpose of simplification and to aid understanding, all that is shown are the cascade vane 28, the contour of the cap element 27 with its inner wall 27int and its outer wall 27ext and the deviation edge 29 upstream of the radial passageways for deviation of the bypass flow.

The deviation edge 29 has a convex curved shape and extends from an upstream plane 29a to the upstream end of the cascade vane 28.

The representation in solid lines corresponds to the axial section in the horizontal plane and the representation in dashed lines corresponds to the axial section in the vertical plane.

It can be seen that the inner wall 27int, which defines the outer wall of the bypass duct, is not a surface of revolution about the axis. This wall extends downstream of the plane 29a, shown by a point in the figures, forming the upstream end of the deviation edge. Upstream of this plane 29a, the outer wall of the bypass duct is not involved in the invention. Thus the duct of the bypass flow 17′ is axi-symmetric on the transverse plane passing through the upstream end 29a of the deviation edge and then deforms progressively in the downstream direction. The fairing 16 of the gas generator defining the inner wall of the duct of the bypass flow 17′ is a surface of revolution; it has a circular section.

The outer wall of the nacelle, of which the outer portion 27ext of the cap element 27 has a reduced radius in the vertical longitudinal plane over a greater length than the inner portion 27int of the cap element. For the application that is the object in this instance of installation under the wing, this reduces the vertical bulk of the nacelle in the bypass flow nozzle portion.

The embodiment shown is not the only one possible; many variants are possible for adapting to the requirements associated with the environment in which the engine is installed.

Thus FIG. 7 shows a variant ovalization of the thrust-reverser cascade vane, marked 28′, in which the large axis AA is inclined at 45° relative to the horizontal direction.

FIG. 8 shows another possible nonlimiting variant. The cascade vane 28″ has one oval shaped portion and another portion having flaps.

Other variants relating to the length of the cascade vane or else the length and the height of the deviation edge or else the shape of the nozzle in the plane of discharge of the bypass flow or a combination of these parameters are possible.

Thus, FIG. 9 shows a variant in which the cap element 127, seen in the vertical longitudinal plane, shown in dashed lines, respectively in the horizontal plane, shown in solid lines, has inner walls 127int and outer walls 127ext that change between the upstream end 129a of the deviation edge 129 and the discharge plane 127f. This variant has the particular feature of a circular shape of the outer wall of the nozzle 127f in the discharge plane. The cascade vane 128 can be seen having a radius that changes between the vertical plane and the horizontal plane.

FIG. 10 shows another variant of nozzle shape combining three features:

The cascade vane 228 changes not only in radius relative to the axis XX but also in length. It length l in the horizontal plane, shown in solid lines, is greater than its length in the vertical plane, shown in dashed line.

The length of the deviation edge 229 measured from its upstream end 229a is on the other hand constant; as can be seen in the figure, the length is the same in the vertical plane and in the horizontal plane.

The outer wall 227f of the nozzle in the discharge plane is circular.

The invention is not limited to the embodiments described; it encompasses all the variants within the scope of those skilled in the art.

1-9. (canceled)

10. A cold-flow nozzle of a bypass turbojet with separate flows, comprising:
an annular cap element that can be moved in axial translation between an upstream retracted position for an operation of the engine in direct thrust and a downstream extension position; and
a cascade vane thrust reverser including cylindrical ring sectors that are coaxial with the cap element, including radially oriented fins, and spaced axially to arrange radial guide passageways between them, the cap element, in the downstream extension position, clearing the radial passageways through the thrust-reverser cascade vanes;
wherein the radius of the ring sectors forming the cascade vanes is not constant along the circumference of the cap element, and
wherein the annular cap element comprises an inner wall delimiting a periphery of a cold-flow duct and an outer wall of a casing of a nacelle, the radius of cross sections of at least one of the walls not being constant, when moving along the circumference of the cap element, the sections being made between an upstream edge of the cap element and its downstream edge.

11. The nozzle as claimed in claim 10, in which the radii of the cascade vanes change between a minimal value and a maximal value, the minimal and maximal values corresponding to planes, radial passing through the axis, perpendicular to one another.

12. The nozzle as claimed in claim 11, wherein of the two planes one is vertical and the other is horizontal.

13. The nozzle as claimed in claim 10, wherein the upstream edge, as a deviation edge, of the radial passageways, is of convex curved shape, the length of its section through a radial plane passing through the axis being constant along the circumference of the cap element.

14. The nozzle as claimed in claim 10, wherein the upstream edge, as a deviation edge of the radial passageways, is of convex curved shape, the length of its section through a radial plane passing through the axis varying along the circumference of the cap element.

15. The nozzle as claimed in claim 10, wherein the length of the cascade vanes measured axially is constant along the circumference of the cap element.

16. The nozzle as claimed in claim 10, wherein the length of the cascade vanes measured axially varies along the circumference of the cap element.

17. The nozzle as claimed in claim 16, wherein the cross sections have an oblong shape, or a smallest of radii of the cross sections is vertical.

18. The nozzle as claimed in claim 17, wherein the downstream edge of the cap element is circular.
